(19) United States
(12) Patent Application Publication
(10) Pub. No.: US 2010/0240345 A1
(43) Pub. Date: Sep. 23, 2010

(54) EVENT NOTIFIER DEVICE AND HEADSET

(75) Inventors: Elin Karrman, Malmo (SE); Karin Harenstam, Malmo (SE); Karan Bilgi, Lund (SE)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(73) Assignee: Sony Ericsson Mobile Communications AB, Lund (SE)

(21) Appl. No.: 12/405,598

(22) Filed: Mar. 17, 2009

(51) Int. Cl. H04M 3/42; H04B 7/14

(52) U.S. Cl. 455/414.1; 455/41.2

(57) ABSTRACT

An event notifier device suitable to be wirelessly associated to a telephone apparatus is disclosed. The event notifier device comprises a receiver arranged to receive a signal wirelessly from the telephone on incoming event notification associated with an event; an output mechanism arranged to provide a human perceivable signal indicating a notification on the event; and a body containing the receiver and the output mechanism, wherein the body further is arranged to be worn by a user of the event notifier device such that the user is enabled to perceive the output signal, wherein the body comprises a fastener. A headset comprising such an event notifier device is also disclosed.

### TECHNICAL FIELD

The present invention relates to an event notifier device and to a headset with such an event notifier device.

### BACKGROUND

Telephones, such as cell phones, are today used and carried by many people, not to say a majority of the population in active age, i.e. small children and really old people excluded, in at least the industrialized part of the world. The use of telephones crosses borders of sex, culture, and social belonging more than any other behaviour, with the absolute basic needs of human being excluded. However, the way of carrying the telephone differs not only because of personal preferences, but can also be noticed due to sex, culture and social belonging, which may be explained by differences in clothing habit due to sex, culture and social belonging.

Telephones often enable use of a ‘silent mode’, where ring signal or buzzer is switched off, and the telephone instead notifies the user of an incoming call by vibrating or providing a light signal. This may also be the case for other events associated with different applications provided in the telephone. However, depending on how the telephone is carried, this may not always alert the user in a desired way. Therefore, there is a desire in improving the provision of an alert of an occurred event in the telephone.

### SUMMARY

The invention is based on the understanding that users may prefer to wear the telephone in a way that they are not able to perceive event notifications from the telephone, such as in a handbag. The inventors have realized that technology makes it feasible to provide an event notifier device, which due to electrical functional and handling functional design according to the invention can be carried such that stimuli provided by the event notifier device can be perceived irrespective of the obstacles discussed above.

According to a first aspect, there is provided an event notifier device suitable to be wirelessly associated to a telephone apparatus. The event notifier device comprises a receiver arranged to receive a signal wirelessly from the telephone on incoming event notification associated with an event; an output mechanism arranged to provide a human perceivable signal indicating a notification on the event; and a body containing the receiver and the output mechanism. The body is further arranged to be worn by a user of the event notifier device such that the user is enabled to perceive the output signal. The body comprises a fastener.

The event notifier device may further comprise a key ring applied to the fastener.

The body may comprise an elongated portion having the fastener at one of its short sides. The elongated portion may further comprises another fastener at the other of its short sides. The fasteners may be adapted to receive a cord of a headset comprising the cord, a headset control body, and at least one earpiece, such that the event notifier device will be placed at the back of the neck of a user when the user is wearing the headset around the neck.

The event notifier device may further comprise a lace applied at the fastener such that the event notifier device is enabled to be carried by a user using the lace. The lace may be adapted such that the event notifier device and the lace is enabled to be worn around an ankle, a wrist, or the neck of a user. The lace may be formed as any of a chain, string or band.

The fastener may comprise any of a lug, snap lock, screw, magnet, clip, and hook.

The event notifier device may be arranged to be paired with the telephone apparatus using Bluetooth such that the event notification images events of an event list application of the telephone. The event notifier device may be arranged to negotiate event notification service connected to the event list application at a Service Discovery Session of the pairing. The event notifier device may have only receiving capabilities, and the pairing comprises that the telephone is set to consider the event notifier device as a parked Bluetooth device.

The output mechanism may comprise a displacement device adapted to displace a portion of the event notifier device upon notification of an event. Displacement of the portion of the event notifier device may cause a movement or a change of appearance of the event notifier device such that a tactile and/or visual stimulus is provided.

According to a second aspect, there is provided a headset device arranged to be wirelessly connected to a telephone. The headset device comprises a headset control body, at least one earpiece, an event notifier device according to the first aspect, and a cord connecting the at least one earpiece, the headset control body and the event notifier device, and forming at least one loop. The event notifier device comprises a receiver arranged to receive a signal on incoming event notification, an output mechanism arranged to provide a human perceivable signal indicating a notification on the event, and a body containing the receiver and the output mechanism. The body is further arranged to be worn by a user of the event notifier device such that the user is enabled to perceive the output signal. The body comprises a fastener for receiving the cord such that the call notifier device will be placed at the back of the neck of a user when the user is wearing the headset around the neck.

The cord from the headset central body may form the loop via the call notifier device, and the cord from the at least one earpiece may connect to the loop in vicinity of the call notifier device.

The body may further comprise an elongated portion having the fastener at at least one of its short sides. The elongated portion may further comprise another fastener at the other of its short sides, and the cord may be received by both of the fasteners.

### BRIEF DESCRIPTION OF DRAWINGS

FIG. 1 schematically illustrates a telephone and an event notifier device.

FIG. 2 schematically illustrates an event notifier device according to an embodiment.

FIG. 3 illustrates an event notifier device with a key ring.

FIG. 4 illustrates an event notifier device with a lace.

FIG. 5 illustrates a headset with an event notifier device.

FIG. 6 illustrates wearing of an event notifier device in a lace around the neck.

FIG. 7 is a front view of a user wearing a headset with an event notifier device.

FIG. 8 is a back view of a user wearing a headset with an event notifier device.

FIG. 9 illustrates wearing of an event notifier device in a lace around a wrist.

FIGS. 10a to 10d illustrate an event notifier device according to an embodiment.

FIGS. 11 and 12 illustrate examples on provision of stimuli according to embodiments.

### DETAILED DESCRIPTION

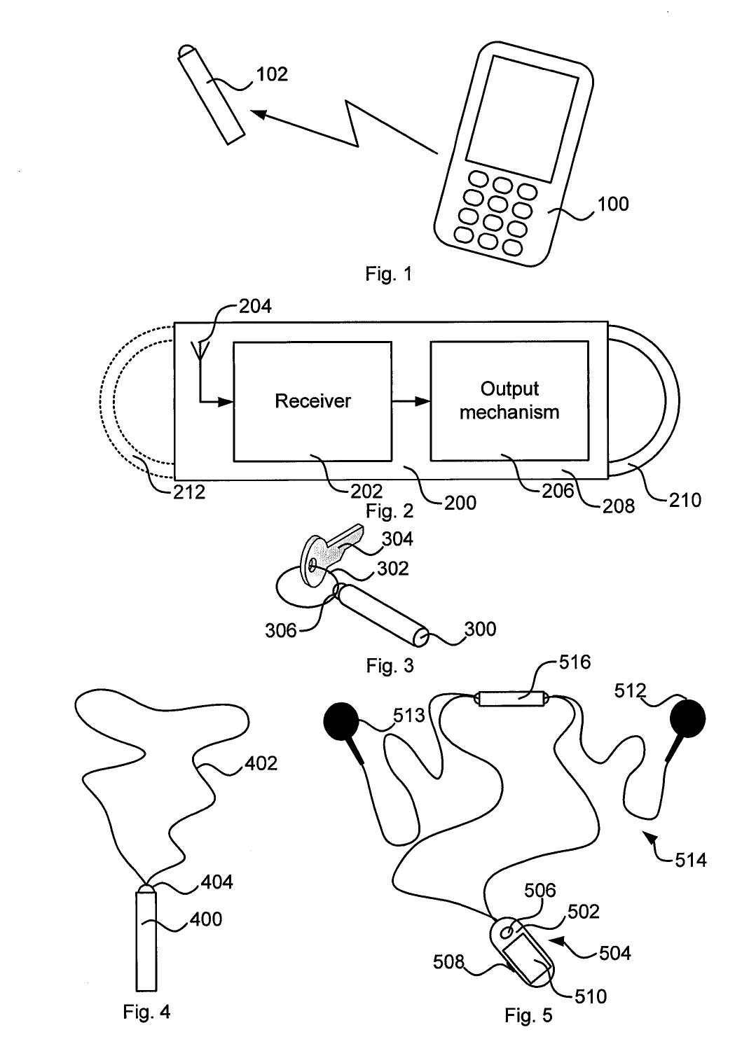

It is technically feasible to provide a signal wirelessly from a telephone 100, such as a cellular telephone, to an event notifier device 102, e.g. by short-range radio communication techniques such as Bluetooth wireless technology, as schematically illustrated in FIG. 1. The event to be notified can be any of an incoming call, a calendar reminder, an incoming message, an alarm or timer event, or other event associated with an application of the telephone. Thus, the short-range radio connection only need to be one-way, which enables a less power consuming, less costly, and smaller solution for the event notifier device 102. As will be demonstrated by different embodiments below, these qualities are particularly advantageous. However, the overall advantage of the event notifier device 102 is that the telephone 100 can be stowed, e.g. in a purse or handbag, and put in silent mode, and the user of the telephone 100 can still become aware of event notifications. When the event notifier device 102 receives the signal wirelessly from the telephone 100, the event notifier device 102, which due to that it is enabled to be small and neatly designed can be easily carried by the user, generates a human perceivable signal indicating the event. The human perceivable signal can be a stimuli based on visual, tactile, or audible effects. Thus, the event notifier device 102 can provide a light signal, a vibration, or a sound for notifying the occurred event. The provided stimuli can be different for different types of events.

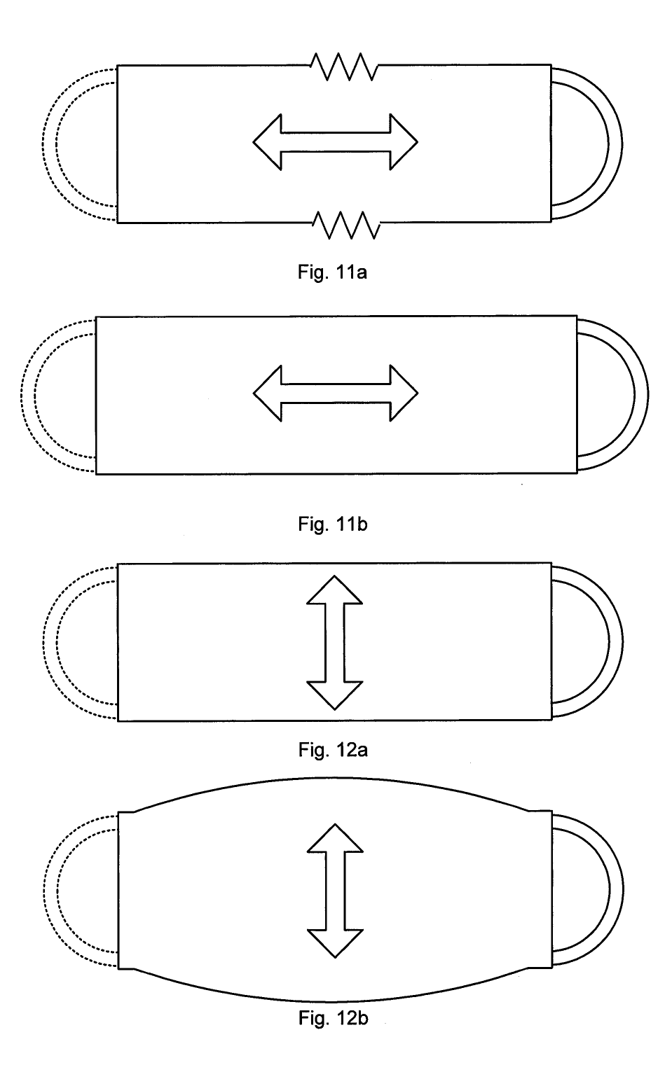

The stimuli can be achieved by a displacement device. The displacements device can for example comprise a solenoid coil with a displaceable core arranged to displace a mass inside the event notifier device 102, or a membrane at the surface of the event notifier device 102. In the latter case, both a tactile and a visual stimuli can be achieved. As an alternative, the displacement device can rely on pressurized air, piezo electric element(s), electroactive polymers, memory alloy, or any other actuator that can be caused to make a controllable displacement. Examples on such displacement devices are disclosed in US 2007/0125636 A1, which is hereby incorporated by reference. Examples for the event notifier device 102 will be given with reference to FIGS. 11 and 12 below.

The communication between the telephone 100 and the event notifier 102 can utilize Bluetooth wireless technology and Bluetooth protocols. According to one embodiment, the telephone 100 and the event notifier 102 perform a pairing operation including a Service Discovery Operation where service is defined to be associated to an event notification application of the telephone 100, which for example also may provide an event list presented to a user in the telephone 100. The event list is preferably provided by an event list application, which creates a list comprising items on for example missed calls, reminders, upcoming calendar events, unread messages, notifications on program updates, etc. The items of the event list can thus be associated with notifications provided to the event notifier 102, which for example provides a certain notification to the user, e.g. when an item appears on the event list, or periodically as long as the item remains on the event list. The notification can be different stimuli, or pattern of stimuli, for different types of items in the event list, e.g. a single vibration burst for a missed call, two bursts of vibration for a message, and multiple bursts of vibration for an upcoming calendar event. The stimuli associated with the event in the list can be mapped by the event list application to the type of item, or be mapped to the type of item by the event notifier 102. Thus, the event notifications can be associated with the items of the event list. The event notification can also be associated to basic functions as notification on incoming phone calls or arrival of messages according to any messaging service supported by the telephone, such as Short Message Service, multimedia or instant messaging, electronic mail, etc. Thus, any occurring event that is to be notified by the phone in ordinary use is now also provided as a signal provided to the event notifier 102 via the established Bluetooth session. This embodiment is suitable if the event notifier is provided with full Bluetooth functionality. According to another embodiment, the event notifier 102 may only be provided with a receiver and no transmitting capability. This can greatly simplify the event notifier 102, both in terms of circuitry requirements and in terms of power consumption. Here, no ordinary pairing operation is possible since the radio communication will be a one-way communication from the telephone 100 to the event notifier 102. Instead, a user may through a user interface of the telephone 100 indicate that an event notifier 102 is to be used. The telephone 100 will then consider the event notifier 102 as a parked Bluetooth device, whereby the one-way communication is enabled. Thus, the telephone 100 will transmit information on any event, and the event notifier 102, which will listen for Bluetooth transmissions, will receive the Bluetooth transmission and arrange for notification on any indicated event provided in the transmission.

Here, there are given examples utilizing Bluetooth wireless technology, but similar principle applies to any short-range radio technology.

FIG. 2 schematically illustrates an event notifier device 200 according to an embodiment. The event notifier device 200 comprises a receiver 202 which is arranged to receive the signal on incoming event notification from the telephone, preferably via an antenna 204. The receiver 202 demodulates and decodes the signal and provides a control signal to an output mechanism 206, which provides the stimuli based on the control signal. Optionally, the event notifier device 200 also includes transmitting capabilities, as has been demonstrated above with reference to FIG. 1. The receiver 202 and the output mechanism 206 are contained in a body 208 which comprises a lug 210 arranged to enable the event notifier device 200 to be easily carried by the user. For example, the lug 210 can be arranged to receive a key ring for attaching the event notifier to the user's key(s), or to receive a lace such that the event notifier device 200 can be carried around the neck, wrist, waist or ankle of the user. Here, “lace” is to be interpreted as any means fulfilling the function, e.g. a chain, string or band. The lug 210 can also be arranged to receive a cord of a headset, e.g. a portable handsfree device. The lug 210 can be fixed, or be provided with a lock mechanism such that the lug 210 can be opened and closed by the user when applying the means to be received by the lug 210.

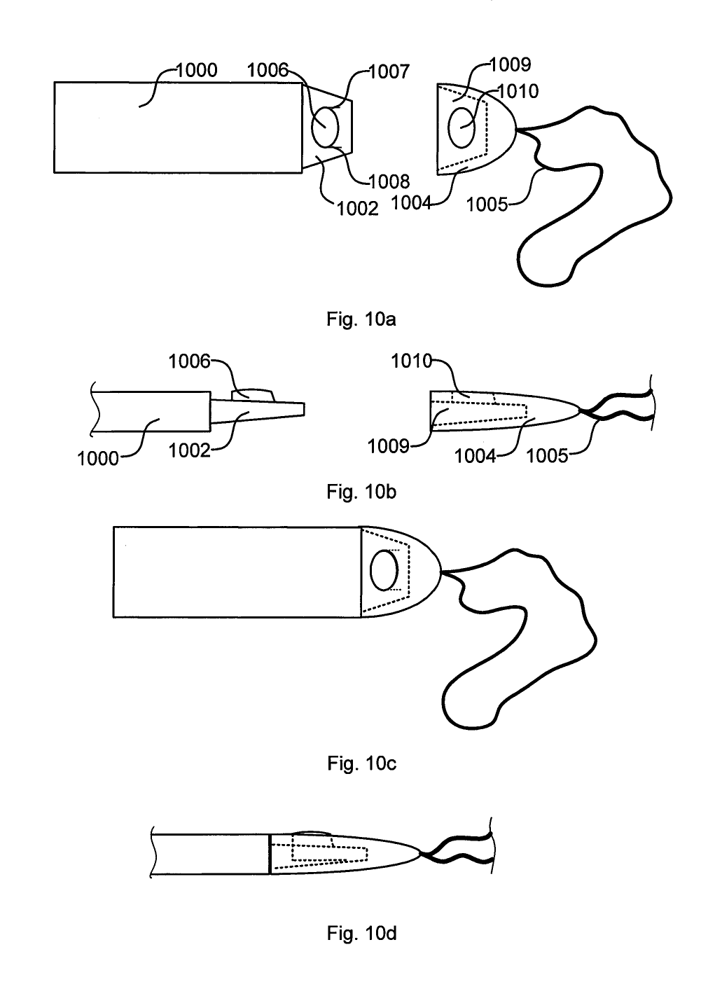

The body 208 can be an elongated member with the lug 210 arranged at one short side of the member. Optionally, the body can comprise a further lug 212 arranged e.g. on the other short side of the member. This provides for further ways to wear the event notifier device 200. FIGS. 3 to 9 illustrates a few examples on how the event notifier device 200 can be arranged and worn, each having their particular advantages, as will be demonstrated below. FIGS. 10a to 10d illustrate an alternative to the lug, a snap lock, which can be used in similar ways of arrangement and wearing as demonstrated for the alternative comprising a lug.

FIG. 3 illustrates an event notifier device 300 with a key ring 302 with a key 304 attached to the lug 306 of the event notifier device 300. This is a suitable way of wearing the event notifier device 300 for those users that have the habit of carrying their keys on them in e.g. a pocket.

FIG. 4 illustrates an event notifier device 400 attached to a lace 402, which forms a loop via a lug 404 of the event notifier device 400. This enables the event notifier to be worn around e.g. the neck, wrist or ankle, wherein the length of the lace 402 should be adapted to the way of wearing it. This is particularly suitable for wearing the event notifier device 400 if the user do not have any pockets available, or do not prefer to have the event notifier in a pocket. Here, a lug 404 is illustrated. However, the lug 404 can be replaced by any of a snap lock, screw, magnet, clip, and hook for receiving the lace 402.

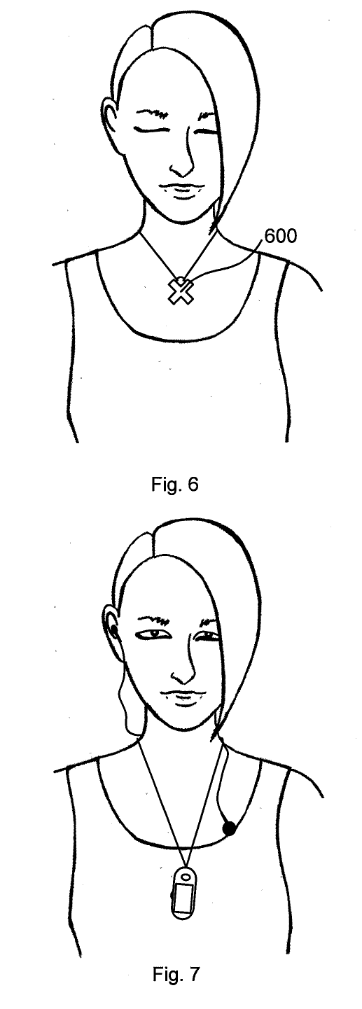

FIG. 5 illustrates a headset 500 arranged to be wirelessly connected to a telephone, e.g. a portable handsfree device. The headset device 500 comprises a headset control body 502, which can comprise a user interface 504 for operating the headset 500. The user interface 504 can for example comprise one or more buttons, a selection input 508 such as a jog dial or navigator key, and/or a display 510. The headset further comprises at least one earpiece 512, 513 and a cord 514 connecting the at least one earpiece. An event notifier device 516 is attached to the cord 514. The cord 514 is arranged from the headset control body via the event notifier device such that it forms at least one loop such that a user is able to wear it around the neck. The event notifier device 516 can be arranged on the cord 514 such that it will be placed at the back of the neck of a user when the user is wearing it around the neck. The cord 514 from the at least one earpiece 512, 513 preferably connects to the loop in vicinity of the call notifier device. Here, a lug is illustrated. However, the lug can be replaced by any of a snap lock, screw, magnet, clip, and hook for attaching the cord 514 to the event notifier device 516.

Circuitry in the headset control body 502 preferably comprises a short-range radio transceiver and a processor for controlling operation of the headset 500, as is known in the art for wireless headsets. With reference to the examples given above for utilization of Bluetooth wireless technology or other short-range radio, the transceiver in the headset control body can work as a master in relation to the event notifier device 516 in terms of radio system structure, or the telephone can work as a master directly for the event notifier device 516. An advantage of having the transceiver in the headset control body 502 as master is that pairing can be pre-defined. An advantage of having the telephone as master is that the event notifier device 516 works independent of the headset 500, e.g. when detaching the event notifier device 516 from the headset 500 and using it with a lace, keyring, etc.

FIG. 6 illustrates an event notifier device 600 worn around the neck in a lace, wherein the event notifier device 600 is hanging on the front side of the body of the user. As the event notifier device 600 enables a large freedom of design, it can also work as a piece of jewellery.

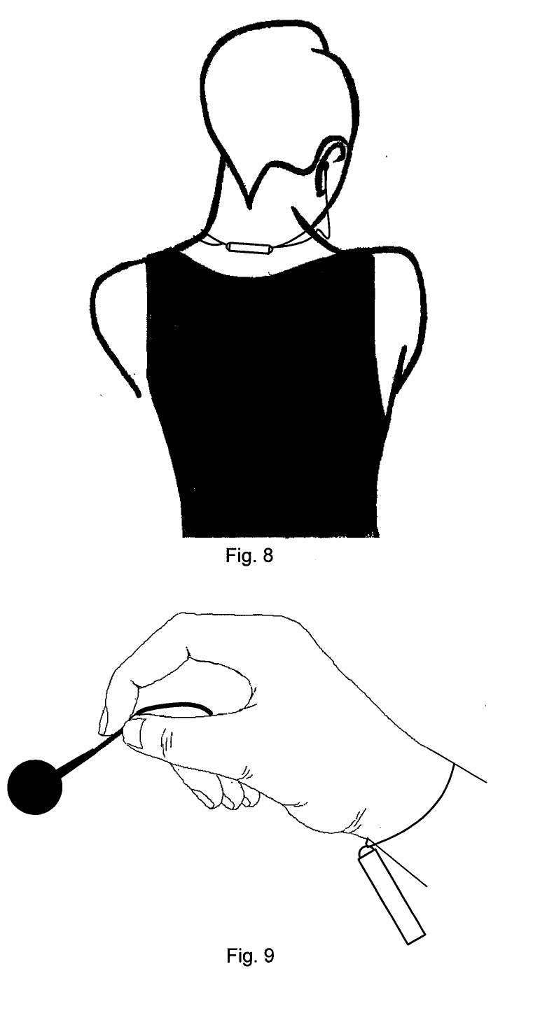

FIG. 7 is a front view of a user wearing a headset similar to the one demonstrated with reference to FIG. 5. Here it can be seen that one earpiece is applied in the ear, while the other rests over the shoulder of the user and is easily reachable for application. FIG. 8 illustrates the user from the other side, where the event notifier device can be seen positioned at the back of the neck of the user.

FIG. 9 illustrates a user wearing the event notifier device in a lace around the wrist.

FIGS. 10a to 10d illustrate an alternative to the lug, a snap lock, which can be used in similar ways of arrangement and wearing as demonstrated for the alternative comprising a lug. FIG. 10a is a top view illustrating an event notifier device 1000 having a fastener 1002 arranged to mate with a corresponding fastener 1004, which for example can be fitted with a lace 1005, for forming a snap lock. The fastener 1002 can comprise a locking element 1006, which also works as a button for operating the lock. The locking element 1006 can for example be arranged in one piece with the fastener 1002 and with cutouts 1007, 1008 such that the locking element is able to flex enough for putting the fasteners 1002, 1004 together and releasing them from each other. The corresponding fastener 1004 is preferably provided by a cavity 1009, where the dashed line illustrates a hidden contour, for receiving the fastener 1002, and with a recess 1010 for receiving the locking element 1006. Here, as in the embodiment with a lug demonstrated with reference to FIG. 2, the event notifier device 1000 can be provided with an optional additional fastener (not shown) at the other end of the event notifier device 1000. Further optionally, the event notifier device can be provided with a snap lock arrangement as illustrated in FIG. 10 at one end and a lug arrangement as illustrated in FIG. 2 at the other end. When the fastener 1002, or the optional additional fastener, is not attached to a corresponding fastener with a lace, keyring, clip, or such, a “blind” fastener having similar features for mating the fastener 1002 can be applied for design reasons, such as being more comfortable to wear and/or make the event notifier device 1000 look nicer. FIG. 10b is a side view illustrating the event notifier device 1000 and the corresponding fastener 1004, where the dashed lines illustrate hidden contours. FIG. 10c is a top view illustrating the event notifier device 1000 and the corresponding fastener 1004 being assembled, and FIG. 10d is a side view illustrating the event notifier device 1000 and the corresponding fastener 1004 being assembled, where the dashed lines illustrate hidden contours. FIGS. 11 and 12 illustrate examples on provision of stimuli according to embodiments. FIG. 11a illustrates an event notifier device in a first state where a displacement device has contracted the event notifier device, while FIG. 11b illustrates the event notifier device in a second state where the displacement device has extracted the event notifier device. Thus, stimuli can be provided by changing from the first or second state to the second or first state, respectively. Alternatively, one or more repetitive changes between the states can be made to provide the stimuli. Both visual and tactile stimuli can be provided this way. FIG. 12 illustrates an event notifier device having e.g. a membrane that can be actuated by a displacement device. FIG. 12a illustrates a first state where a displacement device has not pushed out the membrane, while FIG. 12b illustrates the event notifier device in a second state where the displacement device has pushed out the membrane. Thus, stimuli can be provided by changing from the first or second state to the second or first state, respectively. Alternatively, one or more repetitive changes between the states can be made to provide the stimuli. Both visual and tactile stimuli can be provided this way.

1. An event notifier device suitable to be wirelessly associated to a telephone apparatus, comprising
a receiver arranged to receive a signal wirelessly from the telephone on incoming event notification associated with an event;
an output mechanism arranged to provide a human perceivable signal indicating a notification on the event; and
a body containing the receiver and the output mechanism, wherein the body further is arranged to be worn by a user of the event notifier device such that the user is enabled to perceive the output signal, wherein the body comprises a fastener.

2. The event notifier device according to claim 1, further comprising a key ring applied to the fastener.

3. The event notifier device according to claim 1, wherein the body comprises an elongated portion having the fastener at one of its short sides

4. The event notifier device according to claim 3, wherein the elongated portion further comprises another fastener at the other of its short sides.

5. The event notifier device according to claim 4, wherein the fasteners are adapted to receive a cord of a headset comprising the cord, a headset control body, and at least one earpiece, such that the event notifier device will be placed at the back of the neck of a user when the user is wearing the headset around the neck.

6. The event notifier device according to claim 1, further comprising a lace applied at the fastener such that the event notifier device is enabled to be carried by a user using the lace.

7. The event notifier device according to claim 6, wherein the lace is adapted such that the event notifier device and the lace is enabled to be worn around an ankle, a wrist, or the neck of a user.

8. The event notifier device according to claim 6, wherein the lace is formed as any of a chain, string or band.

9. The event notifier device according to claim 1, wherein the fastener comprises any of a lug, snap lock, screw, magnet, clip, and hook.

10. The event notifier device according to claim 1, wherein the event notification images items of an event list of the telephone.

11. The event notifier device according to claim 10, being arranged to be paired with the telephone apparatus using Bluetooth such that the event notification images events of the event list application of the telephone.

12. The event notifier device according to claim 11, being arranged to negotiate event notification service connected to the event list application at a Service Discovery Session of the pairing.

13. The event notifier device according to claim 11, having only receiving capabilities, and the pairing comprises that the telephone is set to consider the event notifier as a parked Bluetooth device.

14. The event notifier device according to claim 1, wherein the output mechanism comprises a displacement device adapted to displace a portion of the event notifier device upon notification of an event.

15. A headset device arranged to be wirelessly connected to a telephone, the headset device comprising a headset control body, at least one earpiece, an event notifier device, and a cord connecting the at least one earpiece, the headset control body and the event notifier device, and forming at least one loop, wherein the event notifier device comprises a receiver arranged to receive a signal on incoming event notification, an output mechanism arranged to provide a human perceivable signal indicating a notification on the event, and a body containing the receiver and the output mechanism, wherein the body further is arranged to be worn by a user of the event notifier device such that the user is enabled to perceive the output signal, and the body comprises a fastener for receiving the cord such that the call notifier device will be placed at the back of the neck of a user when the user is wearing the headset around the neck.

16. The headset according to claim 15, wherein the cord from the headset central body form the loop via the call notifier device, and the cord from the at least one earpiece connects to the loop in vicinity of the call notifier device.

17. The headset according to claim 15, wherein the body further comprises an elongated portion having the fastener at at least one of its short sides.

18. The headset according to claim 17, wherein the elongated portion further comprises another fastener at the other of its short sides, and the cord is received by both of the fasteners.
